(19) United States
(12) Patent Application Publication
(10) Pub. No.: US 2014/0245733 A1
(43) Pub. Date: Sep. 4, 2014

(54) IN-LINE PARALLEL STANDPIPE MANIFOLD

(71) Applicant: DEERE & COMPANY, Moline, IL (US)

(72) Inventors: Mark White, Dubuque, IA (US); Kerry Cone, Dubuque, IA (US)

(73) Assignee: Deere & Company, Moline, IL (US)

(21) Appl. No.: 13/782,370

(22) Filed: Mar. 1, 2013

(51) Int. Cl. F15B 15/20; F16L 51/00

(52) U.S. Cl. CPC F15B 15/20; F16L 51/00
USPC 60/469; 138/26

(57) ABSTRACT

The present disclosure relates to an apparatus for attenuating fluid ripple in a fluid circuit. A standpipe manifold may include multiple standpipes coupled to a fluid conduit at a same axial location. The multiple standpipes may be configured to attenuate different frequencies of fluid pressure waves passing through the fluid conduit.

### FIELD

The present disclosure relates to an apparatus for attenuating fluid ripple in a fluid system, and more particularly to an in-line parallel standpipe manifold for attenuating fluid ripple in a fluid system.

### BACKGROUND AND SUMMARY

Fluid circuits use pressurized hydraulic or pneumatic fluid to drive machinery. A fluid pump pushes the fluid through one or more pump lines, such as hoses or other conduits, to at least one component, such as an actuator, to control that component. Fluid circuits often exhibit noise or pressure ripple within the pump lines due to fluid pressure wave fronts generated by the pump. In fluid control systems of mobile machines, for example, such pressure ripple may cause the fluid hoses to vibrate or to strike against the machine, thereby creating audible noise and potentially damaging nearby components and reducing the life of the hose.

Noise attenuators are configured to reduce the pressure ripple in fluid lines. Exemplary noise attenuators for hydraulic systems include expansion chambers, Quincke tubes, accumulators, Helmholtz resonators, inline suppressors, and resonator hoses. In an expansion chamber, the pressure waves in the hose enter a larger volume chamber and reflect within chamber to attenuate the pressure waves. However, an expansion chamber only provides for broad attenuation and cannot target specific wave frequencies. A Quincke tube divides the fluid in the hose into two flow paths of unequal lengths, and an attenuation of a particular wave frequency may occur where the two flow paths rejoin. An inline suppressor uses a bladder to dampen incoming pressure waves. An accumulator uses the compression and expansion of gas in the chamber to attenuate pressure waves. A resonator hose includes a smaller hose that is inserted within the hydraulic line to attenuate hydraulic noise. Current noise attenuators fail to provide a compact solution for targeting multiple specific frequencies in the hydraulic circuit.

According to an embodiment of the present disclosure, a noise attenuation apparatus is provided for a fluid circuit. The apparatus includes a first standpipe coupled to a fluid conduit of the fluid circuit. The first standpipe is in fluid communication with the fluid conduit and is configured to attenuate a first frequency of fluid pressure waves passing through the fluid conduit. The apparatus includes a second standpipe coupled to the fluid conduit at a same axial location of the fluid conduit as the first standpipe. The second standpipe is in fluid communication with the fluid conduit and is configured to attenuate a second frequency of fluid pressure waves passing through the fluid conduit. The second frequency is different from the first frequency.

### BRIEF DESCRIPTION OF THE DRAWINGS

The above-mentioned and other features and advantages of the invention, and the manner of attaining them, will become more apparent and the disclosure itself will be better understood by reference to the following description taken in conjunction with the accompanying drawings, wherein:

FIG. 1 illustrates an exemplary vehicle incorporating the standpipe manifold of the present disclosure;

FIG. 2 illustrates a representative view of an exemplary hydraulic circuit of the vehicle of FIG. 1;

FIG. 3 illustrates a perspective view of an exemplary standpipe manifold coupled to a hydraulic conduit;

FIG. 4 illustrates an exemplary cross-sectional view of the standpipe manifold of FIG. 3 taken along line 4-4 of FIG. 3 according to an embodiment;

FIG. 5 illustrates another exemplary cross-sectional view of the standpipe manifold of FIG. 3 taken along line 4-4 of FIG. 3 according to another embodiment;

FIG. 6 illustrates another exemplary cross-sectional view of the standpipe manifold of FIG. 3 taken along line 6-6 of FIG. 3 according to another embodiment;

FIG. 7 illustrates another exemplary cross-sectional view of the standpipe manifold of FIG. 3 taken along line 4-4 of FIG. 3 according to yet another embodiment;

FIG. 8 illustrates an exemplary longitudinal pressure wave of fluid in a hydraulic conduit; and

FIG. 9 illustrates exemplary waveforms depicting the resultant magnitude of pressure waves in the conduit of FIG. 8 before and after passing through the standpipe manifold of the present disclosure.

Corresponding reference characters indicate corresponding parts throughout the several views. The exemplifications set out herein illustrate exemplary embodiments of the invention, and such exemplifications are not to be construed as limiting the scope of the invention in any manner.

### DETAILED DESCRIPTION

The embodiments disclosed herein are not intended to be exhaustive or to limit the disclosure to the precise forms disclosed in the following detailed description. Rather, the embodiments are chosen and described so that others skilled in the art may utilize their teachings.

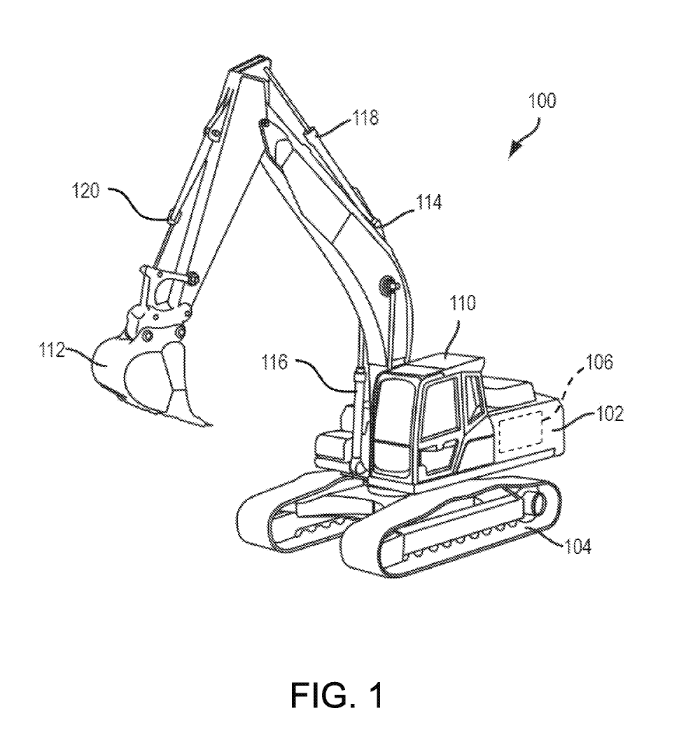

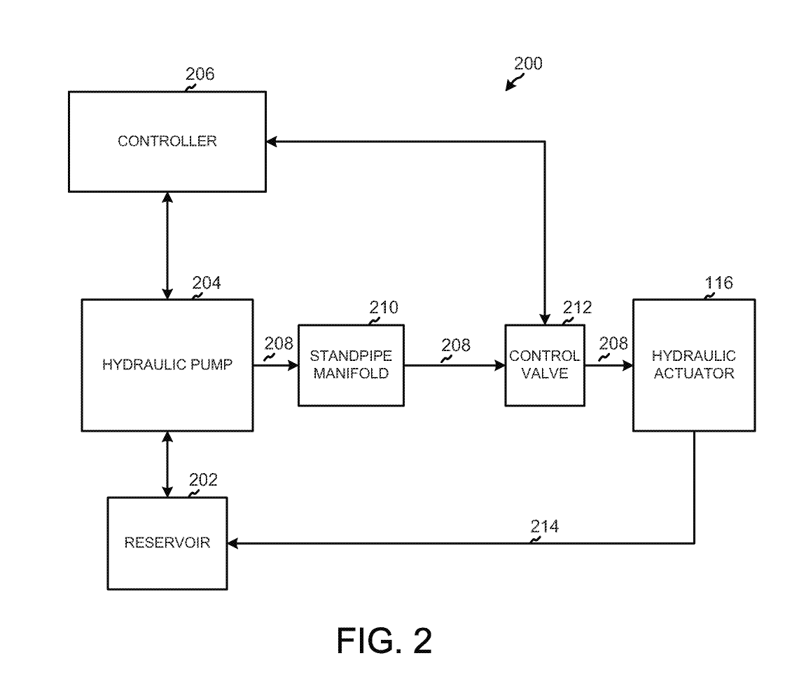

Referring initially to FIG. 1, a work vehicle 100 is illustrated in the form of an excavator. Although vehicle 100 is illustrated and described herein as an excavator, vehicle 100 may also be in the form of a loader, a bulldozer, a motor grader, a tractor, a feller buncher, a crawler, a skidder, a forwarder, or another construction, agricultural, or utility vehicle, for example. Vehicle 100 includes a hydraulic system (see FIG. 2) for powering various vehicle components, such as a bucket 112 for example, as described herein.

Vehicle 100 includes a chassis 102. At least one traction device 104, illustratively a plurality of tracks, is provided to support chassis 102 on the ground. Although fraction devices 104 are in the form of tracks in FIG. 1, it is also within the scope of the present disclosure that traction devices 104 may be in the form of wheels, for example. Vehicle 100 also includes an engine 106 that communicates with traction devices 104 to propel chassis 102 across the ground. Vehicle 100 further includes an operator cab 110 supported by chassis 102 to house and protect the operator of vehicle 100. Operator cab 110 may include a seat and various controls or user inputs for operating vehicle 100 including, for example, user inputs for controlling the hydraulic system of vehicle 100.

Vehicle 100 further includes at least one work tool, illustratively a front-mounted bucket 112. Bucket 112 is movably coupled to chassis 102 via a boom assembly 114 for scooping, carrying, and dumping dirt and other materials. Other suitable work tools include, for example, blades, forks, tillers, mowers, bail lifts, augers, harvesters, grapples, etc. A plurality of hydraulic cylinders 116, 118, 120 are also provided to achieve movement of bucket 112 and/or boom assembly 114 relative to chassis 102.

Referring to FIG. 2, an exemplary hydraulic system or circuit 200 is illustrated for operating various components of vehicle 100. The illustrative hydraulic system 200 of FIG. 2 includes a reservoir 202 of hydraulic fluid (e.g., oil), at least one hydraulic pump 204, and a flow control valve 212 in fluid communication with a hydraulic actuator 116, illustratively hydraulic cylinder 116 of FIG. 1. A hydraulic line or conduit 208 is coupled to an outlet of pump 204 and is routed to the inlet of hydraulic actuator 116 for transferring fluid therebetween. A hydraulic conduit 214 serves as a fluid return line from actuator 116 to reservoir 202. While a single hydraulic actuator 116 is shown in FIG. 2 for illustrative purposes, additional hydraulic actuators, such as hydraulic cylinders 118, 120 of FIG. 1, may also be controlled by the one or more hydraulic pumps 204. In operation, pump 204 directs hydraulic fluid from source 202 to hydraulic cylinder 116 over hydraulic conduit 208 via flow control valve 212 to move bucket 112 and/or boom assembly 114 relative to chassis 102 (FIG. 1). Hydraulic system 200 may also direct hydraulic fluid to hydraulic motors (not shown) and/or other hydraulic actuators other than hydraulic cylinders 116, 118, 120 to perform other hydraulic functions of vehicle 100.

Hydraulic conduits 208, 214 each include one or more hoses or other suitable hydraulic lines for transferring fluid in hydraulic system 200. Conduits 208, 214 may include flexible or rigid hoses. Flow control valve 212 is operative to control the fluid pressure and flow to hydraulic cylinder 116. Additional flow control devices may be provided on lines 208, 214 to control the pressure and flow of hydraulic fluid in lines 208, 214.

In one embodiment, a controller 206 is operative to control operation of hydraulic pump 204 and flow control valve 212. In one embodiment, controller 206 includes a processor and memory containing instructions executed by the processor for electrically controlling pump 204 and valve 212. Hydraulic pump 204 may be driven by an engine, motor, or other suitable prime mover. In one embodiment, controller 206 electrically controls a speed of the engine or motor to control the speed of pump 204. In one example, controller 206 controls pump 204 and valve 212 based on user input provided with operator controls in operator cab 110.

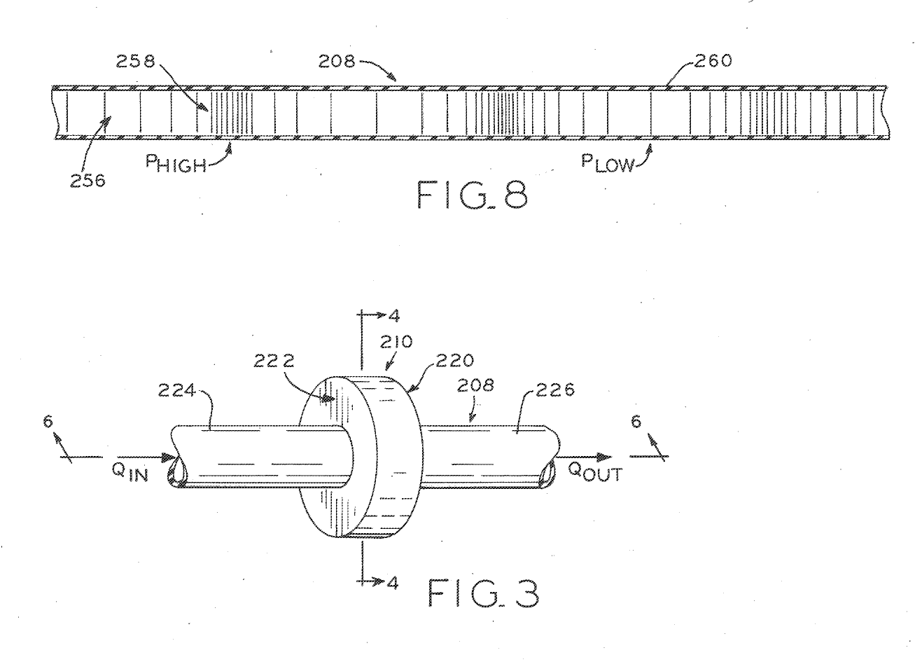

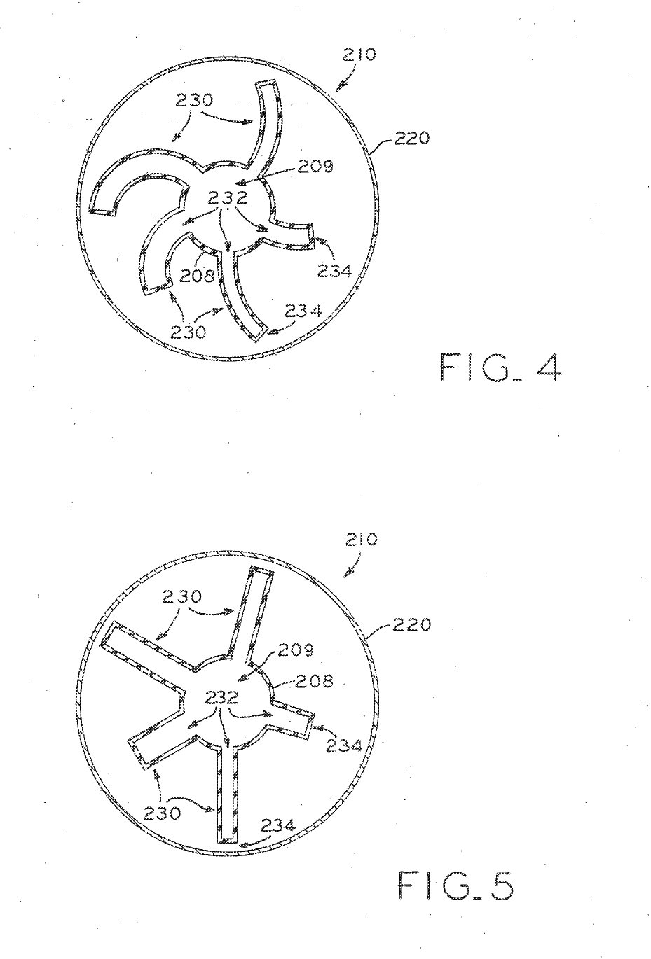

As illustrated in FIG. 2, a standpipe manifold 210 is coupled in-line with hydraulic conduit 208 to attenuate pressure ripple of the fluid passing through conduit 208. In particular, standpipe manifold 210 includes multiple standpipes (see standpipes 230 of FIGS. 4-7) coupled to and in fluid communication with conduit 208 for attenuating multiple different frequencies of pressure waves passing through conduit 208. In one embodiment, the pressure waves are generated by the reciprocating action of cylinders of pump 204 or by other actuation of pump 204. In one embodiment, each standpipe is configured to attenuate a different frequency of the fluid pressure waves within conduit 208. Alternatively, two or more standpipes of manifold 210 may be configured to attenuate the same pressure wave frequency.

While the standpipe manifold 210 of the present disclosure is described as being used on a hydraulic system 200 of a vehicle, the standpipe manifold may be used with any pneumatic or hydraulic system in vehicle or non-vehicle applications.

Standpipe manifold 210 may be coupled at any suitable location along conduit 208 between pump 204 and actuator 116. In one exemplary embodiment, standpipe manifold 210 is coupled at or near the outlet of pump 204 such that no hydraulic circuit components other than conduit 208 are coupled between the outlet of pump 204 and manifold 210. As such, all other hydraulic components are coupled to conduit 208 downstream from manifold 210. In this embodiment, manifold 210 serves to reduce fluid noise within conduit 208 near the outlet of pump 204 to reduce the likelihood of the noise traveling down conduit 208 to the other downstream components (e.g., valve 212, actuator 116, etc.). In one embodiment, manifold 210 is coupled to conduit 208 such that several feet of conduit 208 extends from pump 204 to manifold 210, although manifold 210 may be coupled at any other suitable location along conduit 208. In one embodiment, vehicle 100 of FIG. 1 includes multiple hydraulic pumps 204, and a standpipe manifold 210 is coupled near the outlet of each pump 204 for attenuating noise in the conduit 208 routed from the respective pump 204.

Referring to FIG. 3, an exemplary standpipe manifold 210 is illustratively coupled to a portion of conduit 208 of hydraulic system 200. Standpipe manifold 210 includes a substantially cylindrical outer housing 220 that includes a pair of opposed walls 222 forming an interior region for housing the standpipes. Housing 220 may include other suitable shapes. In some embodiments, housing 220 is optional. In an exemplary embodiment, conduit 208 includes a hose portion 224 routed from pump 204 to manifold 210 and a hose portion 226 routed from manifold 210 to downstream components. As illustrated, fluid flows from pump 204 into manifold 210 (Qᵢₙ) via hose portion 224 and flows out of manifold 210 (Qₒᵤₜ) via hose portion 226. In one embodiment, hose portions 224, 226 include end connectors for attaching to corresponding connectors of housing 220 to provided a sealed connection between manifold 210 and hose portions 224, 226. Hose portions 224, 226 may also be integrally formed with the standpipes of manifold 210.

Referring to FIG. 4, a cross-sectional view of standpipe manifold 210 taken along line 4-4 of FIG. 3 is illustrated according to an embodiment. As illustrated in FIG. 4, conduit 208 extends through manifold 210 and includes a central channel 209 in the interior of housing 220. In one embodiment, central channel 209 includes tube portions 224, 226 of FIG. 3 extending through manifold 210. Alternatively, central channel 209 is formed within housing 220 and coupled to tube portions 224, 226 to transfer fluid from tube portion 224 to tube portion 226. In the illustrated embodiment, central channel 209 has the same cross-sectional area and diameter as tube portions 224, 226.

A plurality of standpipes 230 are coupled to central channel 209 of conduit 208 within housing 220. Standpipes 230, also referred to as side branches or branch line resonators, include hollow tubes that receive and reflect fluid passing through conduit 208. Each standpipe 230 includes an open end or inlet 232 and a closed end 234 opposite the open end 232. Open end 232 of each standpipe 230 is coupled to conduit 208 at a corresponding opening of central channel 209 such that each standpipe 230 is in fluid communication with conduit 208. Closed end 234 is operative to reflect the fluid (and therefore the pressure waves) entering the standpipe 230 back towards open end 232 and into central channel 209 of conduit 208, as described herein. As such, fluid passing through central channel 209 of conduit 208 enters each standpipe 230 at open end 232, bounces off the wall of closed end 234, and exits back into central channel 209 from the standpipe 230 at open end 232.

In the exemplary embodiment of FIG. 4, standpipes 230 are curved along their lengths such that the standpipes 230 have an arced or bent profile. As such, the radial distance that each standpipe 230 extends outwardly from conduit 208, and thus the outer profile of manifold 210, is reduced with the curved standpipes 230. FIG. 5 illustrates a cross-section (taken along line 4-4 of FIG. 3) of another embodiment of manifold 210, wherein the standpipes 230 are substantially straight and extend perpendicular to conduit 208.

Standpipes 230 are sized to attenuate (i.e., reduce the magnitude of) or substantially cancel out various frequencies of pressure waves passing through conduit 208. In the illustrated embodiment, each standpipe 230 is configured to attenuate a target frequency of the pressure waves. The target frequency that each standpipe 230 attenuates is based on the length and cross-section (and/or diameter) of the standpipe 230. In the illustrated embodiment of FIGS. 4 and 5, the standpipe length, illustratively defined between open end 232 and closed end 234, varies for each standpipe 230 such that each standpipe 230 attenuates a different target frequency. In one embodiment, the diameter and/or cross-section of one or more standpipes 230 of manifold 210 also varies between standpipes 230. As described herein, the pressure waves entering and exiting a particular standpipe 230 are configured to attenuate or substantially cancel out the pressure waves passing through conduit 208 that have the associated target frequency, thereby reducing noise due to pressure ripple within the hydraulic circuit.

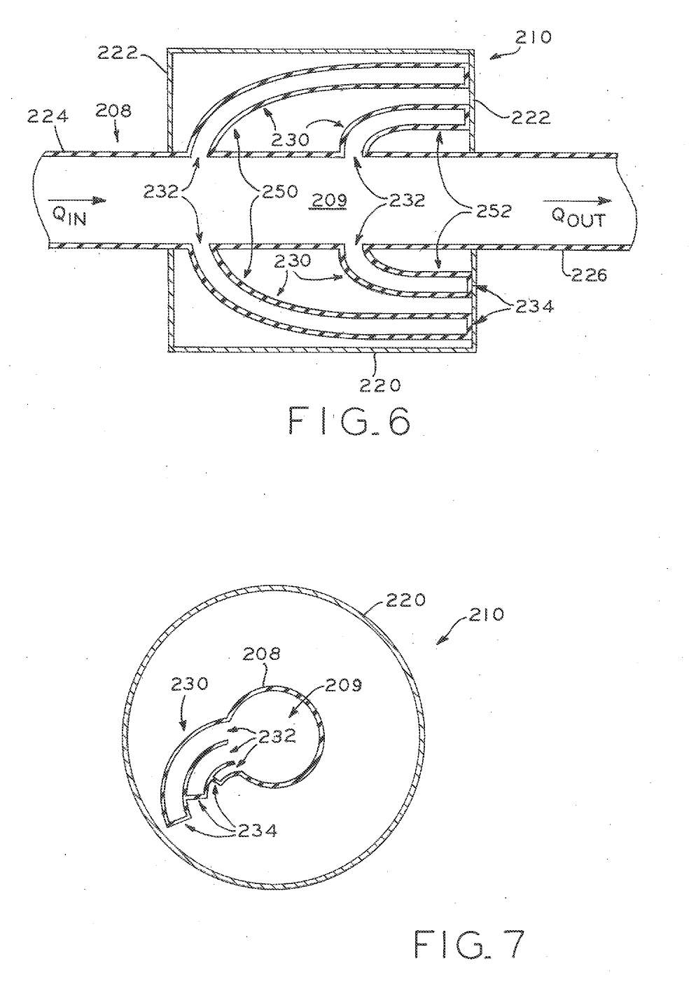

In the illustrated embodiment of FIGS. 4 and 5, multiple standpipes 230 are coupled at a same axial location (i.e., longitudinal position) of conduit 208 and are distributed around the circumference of conduit 208. In particular, at least a portion of each inlet 232 of the standpipes 230 is aligned axially along conduit 208. As such, the inlet flow paths of standpipes 230 overlap axially along conduit 208. With this parallel standpipe arrangement, multiple target frequencies are attenuated at a same axial location or region of the fluid conduit 208. Additional standpipes 230 may be positioned at different axial locations along conduit 208, as described herein with respect to FIG. 6.

The standpipes 230 of FIGS. 4 and 5 are illustratively spaced apart around the outer circumference of conduit 208. Alternatively, standpipes 230 may be adjacent to each other along the outer circumference of conduit 208, as illustrated in the exemplary embodiment of FIG. 7. As such, the axially aligned standpipes 230 may be arranged at any suitable location along the circumference of conduit 208 to accommodate spacing and packaging needs of the system or vehicle. In one embodiment, one or standpipes 230 may extend outside of housing 220.

Referring to FIG. 6, another exemplary cross-section of standpipe manifold 210 taken along line 6-6 of FIG. 3 is illustrated with standpipes 230 routed both radially outward from and axially along a length of conduit 208. In FIG. 6, the inlets 232 of a first set 250 of standpipes 230 are axially aligned with each other, and the lengths extend along conduit 208 towards a wall 222 of housing 220, illustratively the downstream or forward wall 222. The inlets 232 of a second set 252 of standpipes 230 are axially aligned with each other and axially offset from the inlets 232 of the first set 250 of standpipes 230. The second set 252 of standpipes 230 also extend axially along conduit 208 towards wall 222 of housing 220. In one embodiment, the closed end 234 of standpipes 230 of FIG. 6 are coupled to the forward wall 222 of housing 220 such that housing 220 supports the standpipes 230. In one embodiment, portions of the standpipes 230 of FIG. 6 are substantially parallel to each other and to conduit 208, although other arrangements may be provided. Each standpipe set 250, 252 may include two or more standpipes 230 distributed around the circumference of conduit 208 at about the same axial location along conduit 208. Each standpipe 230 in each set 250, 252 may be sized to attenuate a different target frequency. Standpipes 230 of FIG. 6 are illustratively curved along their lengths between the open and closed ends 232, 234, thereby reducing the radial distance from conduit 208 that each standpipe 230 extends. In one embodiment, each end 234 of standpipes 230 of FIG. 6 is open and configured to receive an adjustment device, such as a threaded plug, that closes off the end 234. The adjustment device is configured to adjust the length of the fluid path through the standpipe 230, as described below, for calibrating and tuning the standpipe 230 to a specific frequency.

Standpipes 230 of FIG. 6 are operative to attenuate or substantially cancel frequencies of pressure waves traveling through conduit 208, as described herein with standpipes 230 of FIGS. 4 and 5. In the illustrated embodiment, the longer standpipes 230 of first set 250 attenuate lower target frequencies, and the shorter standpipes 230 of second set 252 attenuate higher target frequencies.

In the illustrated embodiment, standpipes 230 of FIGS. 4-7 are made of a rigid material, such as a metal for example. Alternatively, standpipes 230 may be made of flexible material. While several parallel standpipes 230 are illustrated in FIGS. 4-7, fewer or additional standpipes 230 may be located in parallel along conduit 208 for attenuating multiple frequencies of fluid pressure waves.

In one embodiment, one or more standpipes 230 include an adjustment mechanism configured to adjust the length (or other dimension) of the standpipe 230, and thereby to calibrate or tune the standpipe 230 to attenuate the desired target frequency. For example, after installing standpipe manifold 210 on a hydraulic line in the field, the lengths of individual standpipes 230 may be calibrated with the adjustment device to better attenuate the target frequencies and reduce system noise. In one embodiment, the adjustment mechanism includes a threaded plug coupled to end 234 of the standpipe 230 and configured to adjust the length of the standpipe 230, as described above with respect to FIG. 6. For example, rotation of the threaded plug causes axial movement of the plug relative to standpipe 230 to thereby shorten or extend the length of the fluid path through the standpipe 230.

Referring to FIG. 8, an exemplary longitudinal pressure wave 258 is illustrated in fluid 256 travelling through a portion 260 of conduit 208. The pressure wave 258 includes regions or lengths of high fluid pressure (e.g., P_{High}) and regions or lengths of low fluid pressure (e.g., P_{Low}) alternating with the high pressure regions. The high and low pressure regions within conduit 208 may be caused by the pump 204 pushing fluid 256 through conduit 208. For example, a piston pump 204 may cause pressure waves with each reciprocation or stroke of the pistons that push fluid into the hydraulic conduit 208. The pressure waves passing through conduit 208 may have multiple different frequencies. While one pressure wave 258 is illustrated in FIG. 8, fluid 256 may have multiple pressure waves of varying frequencies that are attenuated with the different sized standpipes 230. In one embodiment, the standpipes 230 of standpipe manifold 210 are configured such that the pressure waves having the largest magnitudes or causing the most pressure ripple are attenuated. The standpipes 230 may be configured based on other suitable criteria.

Standpipe 230 is configured reflect high pressure fluid back into central channel 209 at a low pressure zone of the fluid in channel 209, and vice versa, thereby attenuating or substantially cancelling out the high pressure zone. In particular, pressure fronts entering standpipe 230 are configured to reflect such that high pressure fronts return to central channel 209 when low pressure fronts within channel 209 are at open end 232 and such that low pressure fronts return to central channel 209 when high pressure fronts in channel 209 are at open end 232 of standpipe 230. In one embodiment, each standpipe 230 is sized to be an integer-multiple of a quarter of the wavelength of the target pressure front. As such, the pressure wave entering the standpipe 230 is shifted by pi/2 radians upon re-entering the central channel 209 at open end 232 compared to the pressure wave in channel 209. As such, the reflecting pressure wave opposes the pressure wave passing through central channel 209, thereby cancelling out the pressure wave having the target frequency and causing a substantially equalized or constant pressure front.

In one embodiment, the target frequency attenuated by a particular standpipe 230 is represented with the following equation:

$${f}_{T} = \frac{c}{4 {L}_{B}} \qquad ( 1 )$$

wherein f_{T} is the target (resonant) frequency to be attenuated, c is the speed of sound through the fluid in conduit 208 in meters per second (m/s), and L_{B} is the length of the standpipe 230 in meters (m). The amount or degree of attenuation of the wave amplitude, referred to herein as transmission loss, may be represented with the following equation:

$$T L = 10 {Log}_{10} [ 1 + {( \frac{{S}_{b}}{2 S} )}^{2} {tan}^{2} ( \frac{π f}{2 {f}_{T}} ) ] \qquad ( 2 )$$

wherein TL is the transmission loss, f is the excitation frequency of the fluid resulting from the attenuation, S is the cross-sectional area of the central channel 209 (in m²), and S_{B} is the cross-sectional area of the standpipe 230 (in m²). As such, a transmission loss that substantially equals the amplitude of the pressure front results in a substantially cancelled out target frequency, and thus a substantially constant or equalized pressure front. In one embodiment, a larger cross-section of standpipe 230 results in a greater transmission loss and thus better attenuation. As illustrated with equation (2), the transmission loss is dependent on the cross-section of the central channel 209 and the cross-section of the standpipe 230.

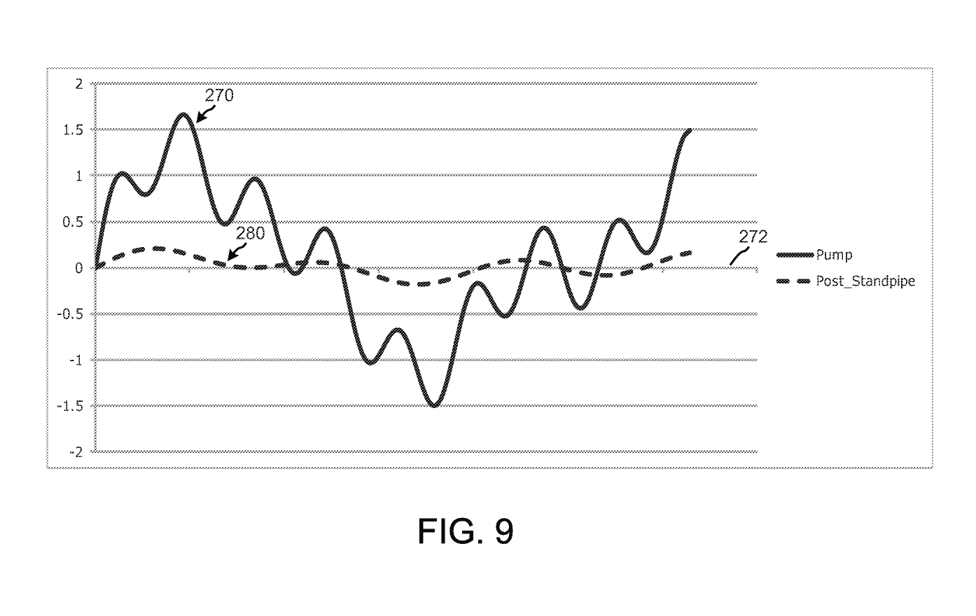

FIG. 9 illustrates an exemplary transverse waveform 270 illustrating a combination of multiple fluid pressure waves having different frequencies and passing through a cross-section of conduit 208 over time. Waveform 270 illustrates the exemplary resultant amplitude of the pressure fronts of the fluid passing through conduit 208. Waveform 270 illustratively includes peaks and valleys that oscillate around an equilibrium pressure level, illustrated with normalized axis 272. As one example, an equilibrium pressure level of axis 272 may be about 30 megapascals (MPa), and waveform 270 may oscillate ±500 kPa about the equilibrium pressure level, for example. Other suitable pressure values may be provided depending on the system configuration.

Waveform 280 illustrates the resultant amplitude of the fluid pressure waves after the fluid passes through the standpipe manifold 210 of the present disclosure. As illustrated, the amplitude of the pressure fronts of the fluid are reduced with standpipes 230, thereby reducing noise within the hydraulic circuit. Standpipes 230 may be further tuned and configured to increase or reduce the amount of attenuation of waveform 270.

While the standpipe manifold 210 is described herein for use in a hydraulic system, the standpipe manifold 210 may also be used with a pneumatic system for attenuating air pressure waves in the system.

While this invention has been described as having preferred designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this disclosure pertains and which fall within the limits of the appended claims.

1. An apparatus for attenuating fluid ripple in a fluid circuit, the apparatus including:
a first standpipe coupled to a fluid conduit of the fluid circuit, the first standpipe being in fluid communication with the fluid conduit and being configured to attenuate a first frequency of fluid pressure waves passing through the fluid conduit; and
a second standpipe coupled to the fluid conduit at a same axial location of the fluid conduit as the first standpipe, the second standpipe being in fluid communication with the fluid conduit and being configured to attenuate a second frequency of fluid pressure waves passing through the fluid conduit, the second frequency being different from the first frequency.

2. The apparatus of claim 1, wherein the first and second standpipes each include an open end and a closed end opposite the open end, and the open end is coupled to the fluid conduit and is configured to receive fluid passing through the fluid conduit.

3. The apparatus of claim 2, wherein the first and second standpipes each have a length extending between the open end and the closed end, and the length of the first standpipe is different from the length of the second standpipe.

4. The apparatus of claim 2, wherein the first and second standpipes each extend axially along the fluid conduit.

5. The apparatus of claim 2, wherein the first standpipe includes an adjustment mechanism configured to adjust the length of the first standpipe.

6. The apparatus of claim 5, wherein the adjustment mechanism includes a threaded plug.

7. The apparatus of claim 1, wherein the first and second standpipes are tubular, and the diameter of the first standpipe is different from the diameter of the second standpipe.

8. The apparatus of claim 1, wherein the first and second standpipes are substantially perpendicular to the fluid conduit.

9. The apparatus of claim 1, wherein the first and second standpipes include rigid tubes.

10. The apparatus of claim 1, further comprising a third standpipe coupled to the fluid conduit at a same axial location of the fluid conduit as the first and second standpipes, the third standpipe being in fluid communication with the fluid conduit and being configured to attenuate a third frequency of fluid pressure waves passing through the fluid conduit, the third frequency being different from the first and second frequencies.

11. The apparatus of claim 1, wherein the fluid circuit is a hydraulic circuit including a hydraulic pump and a hydraulic actuator, and the fluid conduit is routed between an outlet of the hydraulic pump and an inlet of the hydraulic actuator, wherein the first and second standpipes are coupled to the fluid conduit near the outlet of the hydraulic pump.

12. The apparatus of claim 1, further including a housing coupled to the fluid conduit, wherein the first and second standpipes are positioned in an interior of the housing.
